(19) United States
(12) Patent Application Publication
(10) Pub. No.: US 2026/0313568 A1
(43) Pub. Date: Oct. 8, 2026

(54) ENERGY EFFICIENT OOK BASED SYNCHRONIZATION SIGNAL

(71) Applicant: Telefonaktiebolaget LM Ericsson (publ), Stockholm (SE)

(72) Inventors: Ravikiran NORY, SAN JOSE, CA (US); Ajit NIMBALKER, DUBLIN, CA (US); Mohammad MOZAFFARI, FREMONT, CA (US); Kittipong KITTICHOKECHAI, JARFALLA (SE); Yanpeng YANG, JARFALLA (SE); Andreas HÖGLUND, SOLNA (SE)

(21) Appl. No.: 19/484,791

(22) PCT Filed: May 15, 2024
(86) PCT No.: PCT/IB2024/054740

§ 371 Date: Nov. 14, 2025

Related U.S. Application Data
(60) Provisional application No. 63/466,576, filed on May 15, 2023.

(51) Int. Cl. H04W 56/00; H04L 27/04; H04W 52/02

(52) U.S. Cl. CPC H04W 56/001; H04L 27/04; H04W 52/028

(57) ABSTRACT

Methods and systems are described for use of on-off keying, OOK, in low power scenarios in UEs, network nodes, and network systems generally. For instance, in one embodiment a UE receives one or more on-off keying, OOK, based periodic lower power synchronization signals, LP-SSs, from a network node. The UE interprets one or more symbols in the one or more OOK-based periodic LP-SSs as ‘ON’ symbols; wherein the ‘ON’ symbols comprise symbols of a first periodic reference signal that is not OOK-based.

### CROSS REFERENCE TO RELATED INFORMATION

This application claims the benefit of United States of America priority application No. 63/466,576 filed on May 15, 2023, titled “Energy efficient OOK based synchronization signal.”

### TECHNICAL FIELD

The present disclosure generally relates to systems and methods for usage of OOK-based and non-OOK-based periodic LP-SSs.

### BACKGROUND

Wake-up receiver (WUR), sometimes also referred to as ‘wake-up radio’, is about enabling a low power receiver in UEs, which, in case of the detection of a wake-up signal (WUS), wakes up the main (baseband/RF/less power efficient) receiver to detect an incoming message, typically paging (e.g. PDCCH in paging occasions (PO), scheduling the paging message on PDSCH). The main benefit of employing WUR is lowering energy consumption and longer device battery life, or at a fixed energy consumption the downlink latency can be reduced (shorter DRX/duty-cycles and more frequent checks for incoming transmissions). FIG. 1 shows an illustration of the location of a WUS and a PO to which it is associated.

In general, there are two approaches for detecting WUS:
Using the main receiver:
   a. No need for additional dedicated hardware/receiver for monitoring WUS
   b. Coverage of the main receiver is not typically impacted
   c. Limited power saving gain as the main receiver monitors WUS
Having a dedicated receiver (WUR):
   a. Extremely low power, simple and low-cost receiver architecture, relaxed requirements, noisier (i.e., less accurate) clock or oscillator
   b. Significant power saving gain can be achieved by maximizing the time in which the main receiver can be in the sleep mode
   c. Enablers for zero energy/battery-less devices, and energy harvesting operations.
   d. There are coverage considerations given the tradeoff between WUR power consumption and sensitivity.

As an example, FIG. 2 shows a dedicated wake up radio (WUR) used for monitoring for a wake-up signal (WUS). Once WUR detects the intended WUS, it wakes up the main (baseband/RF/less power efficient) receiver to detect further incoming messages. Therefore, the main receiver can go to sleep mode and save power until it is triggered by WUR. Here, the WUR is an ultra-low power and low-complexity receiver which can support simple modulation schemes such as OOK, FSK, or PSK. However, the WUS is transmitted using an OFDM-based transmitter.

### WUS for NB-IoT and LTE-M in Release 15

In Rel-15 WUS was specified for NB-IoT and LTE-M. The main motivation was UE energy consumption reduction since with the coverage enhancement PDCCH could be repeated many times and the WUS is relatively much shorter and hence requires less reception time for the UE. The logic is that a UE would check for a WUS a certain time before its PO, and only if a WUS is detected the UE would continue to check for PDCCH in the PO, and if not, which is most of the time, the UE can go back to a sleep state to conserve energy. Due to the coverage enhancements the WUS can be of variable length depending on the UE's coverage, see FIG. 3. FIG. 3 shows an illustration of WUS for NB-IoT and LTE-M. There may be a configured maximum WUS duration and a gap between that and a PO.

A ‘Wake-up signal’ (WUS) is based on the transmission of a short signal that indicates to the UE that it should continue to decode the DL control channel e.g. full NPDCCH for NB-IoT. If such signal is absent (DTX i.e. UE does not detect it) then the UE can go back to sleep without decoding the DL control channel. The decoding time for a WUS is considerably shorter than that of the full NPDCCH since it essentially only needs to contain one bit of information whereas the NPDCCH may contain up to 35 bits of information. This, in turn, reduces UE power consumption and leads to longer UE battery life. The WUS would be transmitted only when there is a paging for the UE. But if there is no paging for the UE then the WUS will not be transmitted (i.e., implying a discontinuous transmission, DTX) and the UE would go back to deep sleep e.g. upon detecting DTX instead of WUS. This is illustrated in FIG. 1, where white blocks indicate possible WUS and PO positions whereas the black boxes indicate actual WUS and PO positions.

The specification of Rel-15 WUS is spread out over several parts of the LTE 36-series standard, e.g., 3GPP TS 36.211; 3GPP TS 36.213; 3GPP TS 36.304; and 3GPP TS 36.331.

### WUS UE Grouping Objective in Rel-16

In the Rel-16 WID, it was agreed that WUS should be further developed to also include UE grouping, such that the number of UEs that are triggered by a WUS is further narrowed down to a smaller subset of the UEs that are associated with a specific paging occasion (PO).

The purpose is to reduce the false paging rate, i.e. avoid that a given UE is unnecessarily woken up by a WUS transmission intended for another UE. This feature is referred to as Rel-16 group WUS, or GWUS. However, this is not directly related to WUR and will not further be explained hereafter.

### Rel-17 NR PEI

In Rel-17 discussions started on introducing a WUS for NR, then called ‘Paging Early Indication’ (PEI). However, since at the time no coverage enhancement was specified for NR, the only gain for Rel-17 PEI was for scenarios where the small fraction of UEs are in bad coverage and with large synchronization error due to the use of longer DRX cycles. The gain for such UEs were that with the use of PEI they would typically only have to acquire one SSB before decoding PEI, instead of up to 3 SSBs if PEI is not used (value according to UE vendors). So, for most UEs, Rel-17 PEI will result in gains or increased performance. Rel-17 PEI will also support UE grouping for false paging reduction, similar to the Rel-16 GWUS above, which will have some gains at higher paging load.

In RAN #93e it was agreed that PEI will be PDCCH-based, as seen in from the next subsection, making it much less interesting for WUR (i.e. the main baseband receiver is required for decoding PEI).

### Rel-18 NR WUR

In Rel-18, there has been rather large interest to introduce WUR for NR, with an ambition for achieving more significant energy efficiency improvement compared to solutions already specified in earlier releases. As explained above, the only specification support needed to be able to use a WUR in the UE, is the specification of a WUS and a long enough time gap between the WUS and the PDCCH in the PO (to allow the UE to start up the main receiver). Therefore, the main difference to Rel-17 PEI is the WUS in Rel-18 should not be PDCCH-based and allow for a simpler and low power receiver, i.e. WUR with simple modulation and detection techniques (e.g. using on-off keying, (OOK) modulation and non-coherent detection).

In Rel-18, a study item on “low-power wake-up signal and receiver for NR” was approved. The relevant justification and objective sections are copied below from RP-213645, “New SID: Study on low-power Wake-up Signal and Receiver for NR”, RAN plenary #94, December 2021:

### Justification

5G systems are designed and developed targeting for both mobile telephony and vertical use cases. Besides latency, reliability, and availability, UE energy efficiency is also critical to 5G. Currently, 5G devices may have to be recharged per week or day, depending on individual's usage time. In general, 5G devices consume tens of milliwatts in RRC idle/inactive state and hundreds of milliwatts in RRC connected state. Designs to prolong battery life is a necessity for improving energy efficiency as well as for better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years as described in TR 38.875. Wearables include smart watches, rings, eHealth related devices, and medical monitoring devices. With typical battery capacity, it is challenging to sustain up to 1-2 weeks as required.

The power consumption depends on the configured length of wake-up periods, e.g., paging cycle. To meet the battery life requirements above, eDRX cycle with large value is expected to be used, resulting in high latency, which is not suitable for such services with requirements of both long battery life and low latency. For example, in fire detection and extinguishment use case, fire shutters shall be closed and fire sprinklers shall be turned on by the actuators within 1 to 2 seconds from the time the fire is detected by sensors, long eDRX cycle cannot meet the delay requirements. eDRX is apparently not suitable for latency-critical use cases. Thus, the intention is to study ultra-low power mechanism that can support low latency in Rel-18, e.g. lower than eDRX latency.

Currently, UEs need to periodically wake up once per DRX cycle, which dominates the power consumption in periods with no signalling or data traffic. If UEs are able to wake up only when they are triggered, e.g., paging, power consumption could be dramatically reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on.

The power consumption for monitoring wake-up signal depends on the wake-up signal design and the hardware module of the wake-up receiver used for signal detecting and processing.

The study should primarily target low-power WUS/WUR for power-sensitive, small form-factor devices including IoT use cases (such as industrial sensors, controllers) and wearables. Other use cases are not precluded, e.g. XR/smart glasses, smart phones.

### Objective of SI

As opposed to the work on UE power savings in previous releases, this study will not require existing signals to be used as WUS. All WUS solutions identified shall be able to operate in a cell supporting legacy UEs. Solutions should target substantial gains compared to the existing Rel-15/16/17 UE power saving mechanisms. Other aspects such as detection performance, coverage, UE complexity, should be covered by the evaluation.

### The Study Item Includes the Following Objectives:

Identify evaluation methodology (including the use cases) & KPIs [RAN1]
   Primarily target low-power WUS/WUR for power-sensitive, small form-factor devices including IoT use cases (such as industrial sensors, controllers) and wearables
      Other use cases are not precluded
Study and evaluate low-power wake-up receiver architectures [RAN1, RAN4]
Study and evaluate wake-up signal designs to support wake-up receivers [RAN1, RAN4]
Study and evaluate L1 procedures and higher layer protocol changes needed to support the wake-up signals [RAN2, RAN1]
Study potential UE power saving gains compared to the existing Rel-15/16/17 UE power saving mechanisms and their coverage availability, as well as latency impact. System impact, such as network power consumption, coexistence with non-low-power-WUR UEs, network coverage/capacity/resource overhead should be included in the study [RAN1]
   Note: The need for RAN2 evaluation will be triggered by RAN1 when necessary.

The benefit of WUR is to reduce the energy consumption of the receiver, such that unless there is any paging and data for the UE it can remain in a power saving state. This will extend the battery life of the device, or alternatively enable shorter downlink latency (shorter DRX) at a fixed battery life. For short-range communication, the WUR power can be low enough (~10 uW) that this can even, in combination with energy harvesting, enable the WUR to be continuously on (i.e. DRX or duty-cycling is not used) without the need for a battery. This can be considered as a key enabler of battery-less devices towards 6G.

### Ambient IoT and Zero Energy Devices

The 3GPP Rel-18 RAN is currently discussing the concept of Zero-Energy (ZE) IoT, also known as Ambient IoT. These devices are designed to operate without the need for manual battery replacement or recharging by harvesting energy from the surrounding environment, resulting in low maintenance and long-lasting functionality. However, the small size, ultra-low cost, and battery-less nature of ZE IoT devices present unique design challenges.

Supporting ZE IoT devices requires significant reduction of power consumption and complexity by simplifying the RF chain and baseband architecture, reducing memory size, and eliminating unnecessary components. To achieve ultra-low power consumption, communication procedures between ZE IoT devices and access points (AP) must be designed as simply as possible. While OFDM may not be suitable for ZE IoT devices due to its high-power consumption requirements, simpler waveforms such as OOK/FSK modulation offer a more promising option for enabling ultra-low complexity data transmission and reception. However, one of the key challenges in adopting these simpler waveforms is ensuring compatibility with existing OFDM-based architecture.

The 3GPP study on Ambient IoT (3GPP TR 22.840) investigates the feasibility of a new IoT technology to open new markets within 3GPP systems, whose number of connections and/or device density can be orders of magnitude higher than existing 3GPP IoT technologies, and which can provide complexity and power consumption orders-of-magnitude lower than existing 3GPP LPWA technologies such as NB-IoT and LTE-MTC.

### IEEE WUR

IEEE 802.11 standardized the support for WUR in the task group (TG) ba. Similar to the 3GPP solution, the use of WUR is only enabled in stations and not in access points (APs), that is for downlink communication only. The AP advertises that it has WUR operation capability, along with WUR configuration parameters (among other info, in which band/channel WUR is operational, which can be different from the band/channel used for data transmission using the main receiver, e.g. WUR in 2.4 GHz band but data communication in 5 GHz band. Also note that the WUR operating channel is advertised in the beacon, and that the WUR discovery operating channel may be different from the WUR operating channel). Stations can then request to be configured with WUR mode of operation. This request has to be granted by the AP, and in case it is granted, the station is further configured/setup for WUR mode of operation (the configuration is only valid for the connection to the associated AP, and further the configuration must be torn down/de-configured if WUR is not used anymore). Both continuous WUR (receiver open all the time) and duty-cycled WUR (receiver only open during preconfigured time slots) mode of operations are supported. For the latter the length of the duty-cycles and on-time during wake up is part of the WUR configuration.

Unlike the 3GPP solution, the WUR operation mode is a “sub-state” of the regular operation and upon the detection of a WUS transmission from the AP, the station will resume the power saving mechanism it was configured with before entering the WUR operation mode. That is, IEEE has specified a number of different power saving mechanisms, and for example if duty-cycled monitoring of the downlink has been configured for the station it will switch to that upon detection of the WUS (i.e. unlike the specified 3GPP mechanism which only covers paging, and the UE will continue to monitor PDCCH if WUS is detected). In this way the IEEE WUR functionality is more general, and still allows for the station to upon detection of WUS “monitor paging” by checking in the beacon from the AP for which stations there is data, or for the station to directly respond with an uplink transmission.

The physical wake-up signal (WUS) in IEEE contains complete frames which must be processed by the station. The drawback with this design is that it requires more handling and processing in the station, i.e. compared to a simple WUR design which trigger one pre-defined activity in case WUS is detected. The benefit is that it contains more information and the solution is more general. The IEEE WUS contains information to indicate if the WUS is a WUR sync beacon, a WUR discovery beacon, or a regular WUS (intended to wake the station up). The WUS can also contain proprietary frames, which could e.g. be used to directly turn actuators on/off. The transmission uses on/off keying (OOK) modulation, using Manchester coding, but is using multi-carrier OOK which can be generated by an OFDM transmitter (i.e. WUR can be enabled as a software upgrade in APs). The WUS is 4 MHz wide, but a whole 20 MHz channel is reserved. The WUS starts with a 20 MHz legacy preamble (to allows other stations to perform carrier sense) followed by 4 MHz Manchester coded OOK. Two data rates are supported: 62.5 kbps and 250 kbps, and link adaptation is up to the AP (each packet is self-contained and includes the data rate, i.e. in the WUR there are two possible sync words used to signal the data rate).

### 5G NR Signals and Channels

Here, some of the key downlink signals and channels in 5G are discussed.

### Synchronization Signal Block (SSB)

The most fundamental aspects of SSB can be summarized as follows (for further detail, see 3GPP TS 38.213, “NR; Physical layer procedures for control”, version 17.0.0, 3GPP Technical specifications).

An SSB contains the Primary Synchronization Signal (PSS), Secondary Synchronization signal (SSS), Physical Broadcast channel (PBCH) along with the Demodulation Reference Signal (DMRS). The BCH carriers the Master Information Block (MIB).

In frequency domain, one SSB occupies 20 contiguous resource blocks which is equivalent to 240 subcarriers, as illustrated in FIG. 4, which shows the time-frequency structure of the SSB. In time domain, one SSB spans over 4 OFDM symbols. Among the four symbols, one symbol is for PSS, one symbol is for SSS, and 2 symbols are for PBCH. Specifically, PSS occupies the first OFDM symbol of SSB and spans over 127 subcarriers. SSS is located in the third OFDM symbol of SSB and spans over 127 subcarriers. The total number of resource elements (REs) used for PBCH transmission per SSB is 576. There are, however, 113 unused subcarriers in the first symbol, and 17 unused subcarriers in the thirds symbol, as shown in FIG. 4. Therefore, there are 130 unused resource elements (REs) within an SSB. In the current NR design, the complex-valued symbols corresponding to these unused REs are set to zero. One or more SSBs can be transmitted per SS burst according with the table 3 below.

“Cell search” for “SS/PBCH block” accounting for different carrier frequencies and subcarrier spacings:
Within one half-frame there are several occurrences of SSBs.
The SSBs can be located in the first or second half of the frame as indicated via MIB.
One or multiple SSBs (i.e., a group of occurrences) compose an SS burst.
The SS burst periodicity can be 5 ms, 10 ms, 20 ms, 40 ms, 80 ms, or 160 ms.

Table 3 shows the maximum number of SSBs per SS burst depending on SCS and carrier frequency.

TABLE 3
Max number of SSBs per SS burst depending
on SCS and carrier frequency

| | | Maximum number of SSBs per SS | | |
|---|---|---|---|---|
| | | burst | | |
| | SCS | | 3 GHz ≤ f_{c} ≤ | |
| | (kHz) | f_{c} < 3 GHz | 6 GHz | 6 GHz < f_{c} |
| Case | 15 | 4 | 8 | |
| A | | | | |
| Case | 30 | 4 | 8 | |
| B | | | | |
| Case | 30 | 4 | 8 | |
| C | | | | |
| Case | 120 | | | 64 |
| D | | | | |
| Case | 240 | | | 64 |
| E | | | | |

The frequency position of an SSB is determined based on the synchronization raster and its mapping to a resource element of SSB.

### NR PDCCH and CORESET

Physical downlink control channel (PDCCH) carries downlink control information (DCI). PDCCHs are transmitted in control resource sets (CORESETs) which span over one, two, or three contiguous OFDM symbols over multiple resource blocks (RBs). In frequency domain, a CORESET can span over one or multiple chunks of 6 RBs. For CORESETs other than CORESET #0, multiple chunks of 6 RBs can be either contiguous or non-contiguous. CORESET #0, which is configured during the initial access, can only have 24, 48, or 96 RBs. Also, CORESET #0 must be contiguous in frequency domain, and it is not necessarily aligned with the six-RB grid.

During initial network access a UE first acquire SSB and decodes the PBCH. The PBCH provides necessary information for the UE to proceed to decode System Information Block 1 (SIB1). SIB1 is transmitted over the physical downlink shared channel (PDSCH) and these resources are indicated by PDCCH. The CORESET and Common Search Space Type #0 configurations are provided by master information block (MIB) obtained from SSB.

Table 1 shows different configurations and bandwidths of CORESET #0. As we can see, the bandwidth of CORESET #0 can be up to 17.28 MHz in FRI (15/30 kHz SCS).

TABLE 1
Different configurations of CORESET #0 in NR

| SCS/ | | | |
|---|---|---|---|
| CORESET | | | |
| duration | one symbol | two symbols | three symbols |
| 15 kHz | −48 RBs (8.64 | −24 RBs (4.32 | −24 RBs (4.32 |
| | MHz) | MHz) | MHz) |
| | −96 RBs (17.28 | 48 RBs (8.64 | 48 RBs (8.64 |
| | MHz) | MHz) | MHz) |
| | | −96 RBs (17.28 | −96 RBs (17.28 |
| | | MHz) | MHz) |
| 30 kHz | −48 RBs (17.28 | −24 RBs (8.64 | −24 RBs (8.64 |
| | MHz) | MHz) | MHz) |
| | | −48 RBs (17.28 | MHz) RBs (17.28 |
| | | MHz) | −48 |

### Reference Signals

Reference signals are predefined signals occupying specific resource elements within the downlink and/or uplink time-frequency grid. The NR specification includes several types of reference signals transmitted in different ways and intended to be used for different purposes by a receiving node. In downlink, the UE uses the demodulation reference signal (DM-RS) and the channel state information reference signal (CSI-RS) to aid channel estimation and to support measurements. For phase noise compensation, the UE uses the PDSCH phase tracking reference signal (PT-RS). Positioning reference signal (PRS) is used to estimate the position of the UE in the wireless network.
Demodulation reference signals (DM-RS) for PDSCH are intended for channel estimation at the device as part of coherent demodulation. They are present only in the resource blocks used for PDSCH transmission.
Phase-tracking reference signals (PT-RS) can be seen as an extension to DM-RS for PDSCH/PUSCH and are intended for phase-noise compensation. The PT-RS is denser in time but sparser in frequency than the DM-RS, and, if configured, occurs only in combination with DM-RS.
CSI reference signals (CSI-RS) are downlink reference signals intended to be used by devices to acquire downlink channel-state information (CSI). Specific instances of CSI reference signals can be configured for time/frequency tracking and mobility measurements.
Tracking reference signals (TRS) are sparse reference signals intended to assist the device in time and frequency tracking. A specific CSI-RS configuration serves the purpose of a TRS.

### SUMMARY

One embodiment under the present disclosure comprises a method performed by a UE for interpreting symbols as OOK symbols. The method comprises receiving one or more OOK based periodic LP-SSs from a network node; and interpreting one or more symbols in the one or more OOK-based periodic LP-SSs as ‘ON’ symbols; wherein the ‘ON’ symbols comprise symbols of a first periodic reference signal that is not OOK-based.

Another embodiment under the present disclosure is a method performed by a network node for transmitting a signal to a UE. The method includes transmitting one or more OOK based periodic LP-SSs to a UE, wherein one or more symbols in the one or more OOK-based periodic LP-SSs are configured to be interpreted as ‘ON’ symbols, and/or wherein one or more additional symbols are configured to be interpreted as ‘OFF’ symbols, wherein a first periodic reference signal is not OOK-based, and wherein the network node reuses the first periodic reference signal as the one or more OOK based periodic LP-SSs for UEs operating in low power mode.

A further embodiment under the present disclosure comprises a method performed by a UE for interpreting symbols as OOK symbols. The method includes the steps of receiving one or more non-OOK, periodic signals from a network node; and interpreting one or more symbols in the one or more non-OOK periodic signals as one or more OOK symbols.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 shows an illustration of the location of a WUS and a PO to which it is associated;

FIG. 2 shows a dedicated wake up radio (WUR) used for monitoring for a wake-up signal (WUS);

FIG. 3 shows an illustration of WUS for NB-IoT and LTE-M;

FIG. 4 shows the time-frequency structure of the SSB;

FIG. 5 shows an example where TRS symbols are used as ON symbols of LP-SS;

FIG. 6 shows an example where SSB symbols are used as ON symbols of LP-SS;

FIG. 7 is an illustration of load situation dependence of OOK LP-SS;

FIG. 8 illustrates a flow-chart of a method embodiment under the present disclosure;

FIG. 9 illustrates a flow-chart of a method embodiment under the present disclosure;

FIG. 10 illustrates a flow-chart of a method embodiment under the present disclosure;

FIG. 11 shows a schematic of a communication system embodiment under the present disclosure;

FIG. 12 shows a schematic of a user equipment embodiment under the present disclosure;

FIG. 13 shows a schematic of a network node embodiment under the present disclosure;

FIG. 14 shows a schematic of a host embodiment under the present disclosure;

FIG. 15 shows a schematic of a virtualization environment embodiment under the present disclosure; and

FIG. 16 shows a schematic representation of an embodiment of communication amongst nodes, hosts, and user equipment under the present disclosure

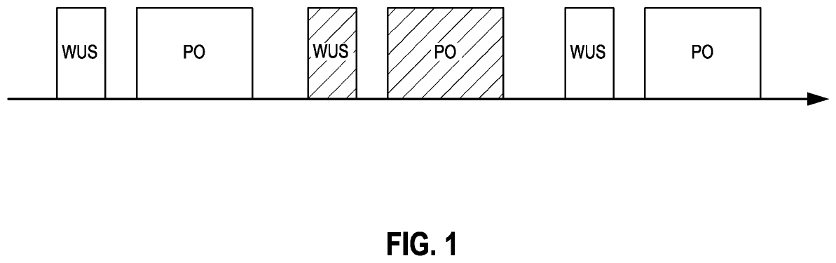

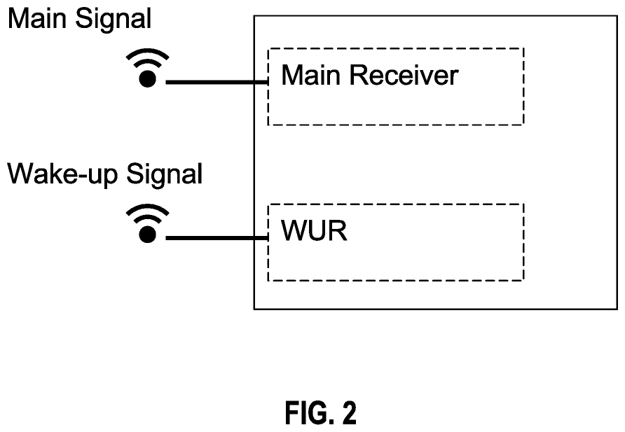

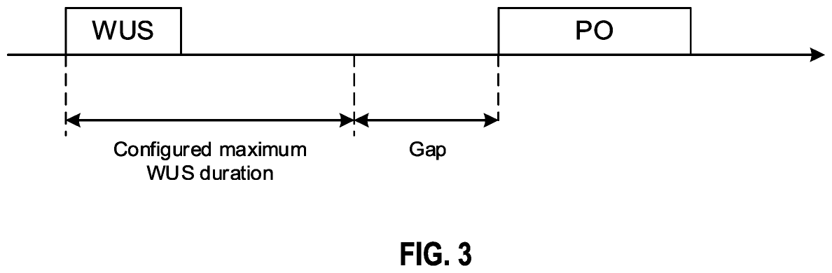

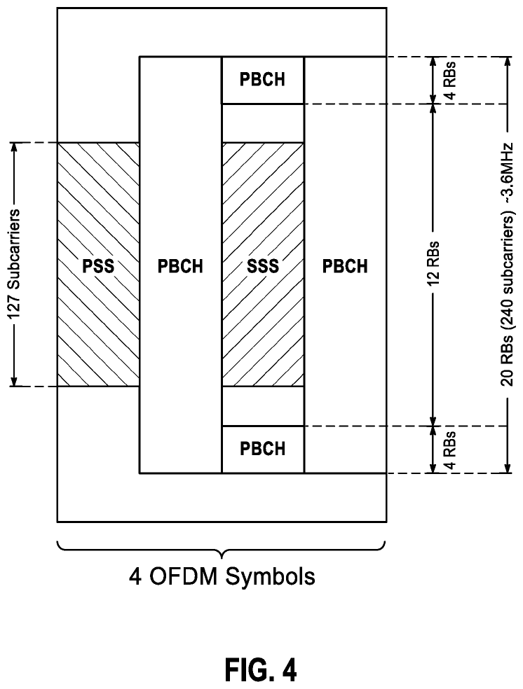

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges. To support synchronization and RRM measurements for simplified wake-up receivers (WUR) based on OOK (on off keying) transmissions, an OOK based periodic low power synchronization signal (LP-SS) is needed. Transmission of such LP-SS increases overhead and gNB energy consumption and methods for efficient LP-SS support with low overhead (in terms of time, frequency, power resources) and low gNB/UE energy consumption are required.

Certain aspects of the disclosure and their embodiments may provide solutions to these or other challenges. For example, certain embodiments can include using an OOK based periodic low power synchronization signal (LP-SS) for RRM measurements or for obtaining time-frequency sync/AGC for an OOK based WUR, where the symbols used for SSB/TRS transmissions are used as ‘ON’ symbols of LP-SS and certain additional symbols (typically adjacent to the SSB/TRS symbols) are considered as OFF symbols of LP-SS. A UE determines the OFF symbols based on gNB signaling. The OFF symbols may be configured around only a subset of SSB/TRS bursts. The UE may also determine the ON symbols based on gNB signaling e.g. only a subset of symbols of SSB/TRS may be utilized as ON symbols.

Certain embodiments may provide one or more of the following technical advantages. SSB/TRS are typically transmitted to support legacy UEs and UEs not receiving OOK based signaling. Having an OOK based LP-SS with a separate set of ON/OFF symbols (e.g., separate from symbols used for SSB/TRS) would increase overhead and gNB energy consumption. With certain embodiments of the present disclosure, gNB can reuse the SSB/TRS transmissions as ON symbols for OOK based LP-SS used by UEs in low power mode. This reduces overhead and gNB energy consumption. From UE perspective, having frequent availability of LP-SS ON symbols (e.g., with same periodicity as SSB/TRS) enables better synchronization and more accurate measurements. This enables more energy efficient UE operation and improved WUR operation in low power mode.

Some of the embodiments contemplated herein will now be described more fully with reference to the accompanying drawings. Embodiments are provided by way of example to convey the scope of the subject matter to those skilled in the art.

In an embodiment, the UE uses a periodic ON/OFF keying (OOK) pattern of OFDM symbols to perform a first set of actions. The periodic OOK pattern of OFDM symbols can be referred to as a low power synchronization signal or LP-SS. At least some of the ‘ON’ symbols of LP-SS overlap in time with OFDM symbols used for a first periodic reference signal (or more generally a periodic transmission of NR signals/channels). The first periodic reference signal/transmission can be for example, an SS/PBCH block (SSB), a CSI-RS used for tracking, or TRS. The ‘OFF’ symbols of LP-SS can be explicitly indicated to the UE e.g., via PHY layer, MAC layer or RRC signaling from gNB.

The first set of actions can include one or more of the following:
obtaining time/frequency synchronization
performing radio resource management (RRM) measurements (e.g., RSRP/RSRQ/RSSI/SINR measurements)
automatic gain control (AGC) related operations for the receiver

If the UE has a main receiver (MR) and low power wake-up receiver (WUR), the LP-SS can be used by UE's WUR while the first periodic reference signal/transmission can then be used by UE's MR. The UE operates in a lower power mode when using WUR compared to when using MR. The first set of actions can help the UE to detect an OOK based wake-up signal (WUS) via WUR. Upon detection of WUS, the UE's MR may use the first periodic reference signal/transmission to obtain time/frequency synchronization or AGC tuning to prepare the UE to receive other NR transmissions such as paging PDCCH/PDSCH and or transmit PRACH and to receive/transmit data. Meanwhile, interactions, and information exchanges between WUR and MR might be needed which can done periodically or in an event-triggered manner.

In an example, the UE determines the ON symbols of LP-SS as the OFDM symbols used for the first periodic reference signal/transmission. Certain symbols adjacent (or near) to the OFDM symbols used for the first periodic reference signal/transmission can be considered by the UE as OFF symbols. The UE can determine OFF symbols based on gNB signaling.

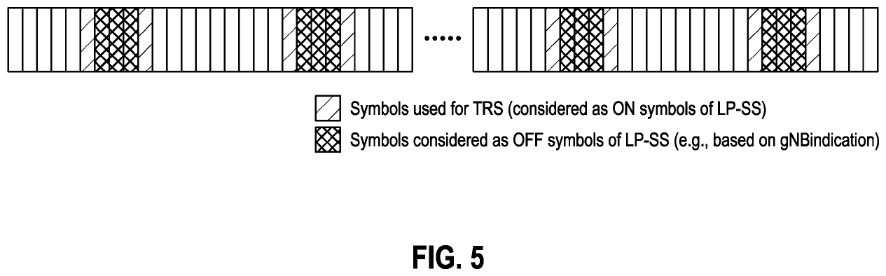

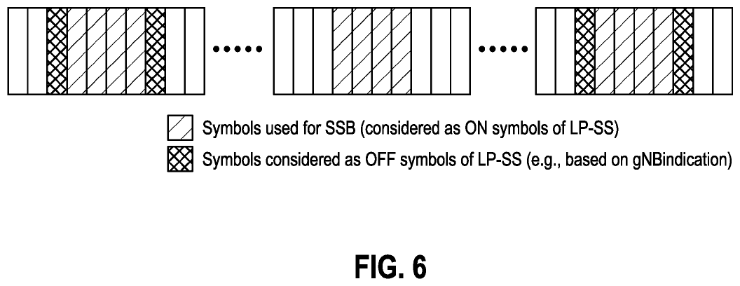

ON symbols can be represented by TRS symbols (FIG. 5) or SSB symbols (FIG. 6).

FIG. 5 shows an example where TRS symbols are used as ON symbols of LP-SS. Typically the TRS symbols are present in bursts of two consecutive slots (e.g., 6^{th} and 10^{th} symbols in each of the two slots) and the bursts are periodic with periodicity of 20 ms/40 ms/80 ms. In this example, an OOK-based LP-SS of pattern 10001 can be formed using some TRS occasions.

FIG. 6 shows an example where SSB symbols are used as ON symbols of LP-SS. Typically the SSB symbols are present in bursts of four consecutive symbols and the bursts are periodic with periodicity of 20 ms/40 ms/80 ms/160 ms. In this example, an OOK-based LP-SS of pattern 011110 can be formed using some SSB occasions.

The figures also show symbols considered by UE as OFF symbols of LP-SS. The symbols that are not considered as either ON symbols or OFF symbols of LP-SS can be considered to be not part of LP-SS. i.e., UE may not use those symbols for performing the first set of actions.

The UE can determine symbols considered as OFF symbols of LP-SS based on gNB signaling.

The ‘ON’ symbols of LP-SS may also be explicitly indicated to the UE e.g., via PHY layer, MAC layer or RRC signaling from gNB. This, for instance, for instance allows a NW to indicate only a subset of OFDM symbols of an SSB or a TRS to be used as ON symbols.

For example, specific LP-SS on/off patterns associated with the first periodic reference signal/transmission (e.g., SSB/TRS) can be predefined and the on/off pattern used by the UE can be determined via broadcast signaling (e.g., SIB, MIB) or other L1 signaling (e.g., the pattern can be adapted via some bits in PDCCH DCI format 2-7 or DCI format 1-0 or some other DCI format) that indicates the pattern.
In one example, if the first periodic reference signal/transmission is SSB, then pattern 1 can be 011110, pattern2 can be 00111100 where the ‘1’s correspond to symbols with SSB (considered as ON symbols of LP-SS) and ‘0’s correspond to symbols immediately before and after the SSB symbols considered by the UE as OFF symbols of LP-SS.
In a second example, if the first periodic reference signal/transmission is TRS, then pattern1 can be 01, pattern 2 can be 10, pattern 3 can be 10001. For patterns 1 and 2, the ‘1’s correspond to symbols with TRS (considered as ON symbols of LP-SS) and ‘0’ s correspond to symbols immediately before or after the TRS symbols respectively that are considered by the UE as OFF symbols of LP-SS. For pattern 3, symbols between the two TRS symbols in each slot can be considered as OFF symbols.
The patterns can be explicitly indicated via bitmaps. Alternately, a predefined pattern index can be indicated.
The ON/OFF patterns can be based on predefined rules such that OFF symbols can be generated based on ON symbols. For example, K zeros (OFF symbols) are added after and/or before some ON symbols. In another example, K zeros (OFF symbols) are added before the first ON symbol and/or after the last ON symbol.
In some cases, both SSB and TRS symbols can be used as part of the ON symbols of LP-SS. In this case, a first pattern configured based on SSB and a second pattern based on TRS can be considered jointly to form a third pattern used for LP-SS.

In another approach, periodicity/slot offsets of the OFF symbols can be determined by RRC signaling, e.g. common RRC and system information broadcast for WUR operation in Idle/Inactive, or dedicated RRC for WUR operation in Connected.

In another example, LP-SS can be configured in system information broadcast where it is configured what is used for ON symbols, e.g., including some/all of OFDM symbols used for SSB, CSI-RS, or TRS, and the configuration of OFF symbols, e.g., a configurable number of symbols before and after some or all SSB transmissions (in which gNB ensures nothing will be transmitted). At cell (re-)selection of the cell, a UE would, even if it is capable of WUR, may start the MR to acquire system information (for all legacy operation and e.g., to see if WUR is configured in the cell). This would also provide initial synchronization to the downlink and also the system frame number (SFN) from MIB. If both the cell and the UE supports WUR operation, the UE can then use WUR to monitor the downlink in the cell, and use LP-SS to maintain synchronization and keep track of SFN (i.e., ensuring the UE does not drift out of radio frame timing and miss its WUS monitoring occasion).

The gNB may adapt the presence/absence of OFF symbols. For example, if the cell load is low, the gNB may configure off symbols around each SSB/TRS burst. When the cell load is high (i.e., more resources needed for data transmissions to various UEs in the cell), the gNB may configure OFF symbols only for a subset of SSB/TRS bursts.

For example, the on/off patterns discussed above can have a periodicity that is different from the (e.g., integer multiple of) periodicity of SSB/TRS.

The bandwidth (BW) for LP-SS can be smaller than the channel/carrier/BWP BW for other NR transmissions. In such cases, in the OFDM symbols considered as OFF symbols for LP-SS, only those PRBs corresponding to LP-SS can be considered to have zero power or no transmission from gNB. Other PRBs in those symbols can be used for other NR physical channels/signals. On the symbols indicated by gNB signaling as OFF symbols for LP-SS, gNB may not transmit any signal on these symbols occupying the frequency domain resources of the LP-SS.

The bandwidth (BW) for LP-SS can be smaller than the BW of the first periodic reference signal/transmission. In such cases, in the OFDM symbols considered as ON symbols for LP-SS, only those PRBs corresponding to LP-SS are considered as part of the LP-SS. In some embodiments, additional ON symbols for LP-SS i.e., in addition to those used by the first periodic reference signal/periodic transmission (e.g., SSB/TRS) can be indicated to the UE. For example, if the first periodic reference signal/transmission is SSB, then a pattern3 10111101 can be used where the first and ‘1’s correspond to additional ON symbols for LP-SS and middle ‘1’s correspond to symbols used for SSB. Similarly, if the first periodic reference signal/transmission is TRS, a pattern 4 10101 can be used where the first and last ‘1’s correspond to symbols used for TRS and the middle ‘1’ is an additional ON symbols for LP-SS. The UE can determine symbols considered as ON symbols of LP-SS (i.e., including the additional ON symbols) based on gNB signaling using the same mechanisms as those described above for determining the OFF symbols. In some embodiments, the UE may use both the LP-SS and the first periodic reference signal/periodic transmission (e.g., SSB/TRS) to perform the first set of actions. For example, if a UE using LP-SS to perform the first set of actions determines that a certain measurement criterion associated with LP-SS is triggered (e.g., RSRP measured using LP-SS is below a certain threshold), it may switch to using the first periodic reference signal/periodic transmission (e.g., SSB/TRS) to perform the first set of actions. Similarly, if the UE, when using SSB/TRS to perform the first set of actions, determines that a certain measurement criterion associated with SSB/TRS is triggered (e.g., RSRP measured using SSB is above a certain threshold), it can switch to using LP-SS to perform the first set of actions.

In some cases it is unknown to the UE what will be transmitted in symbols not configured as ON or OFF, and it is not straight forward for the UE to identify the LP-SS in varying load conditions. This is illustrated in 2.23-3 which shows a schematic illustration of load situation dependence of OOK LP-SS.

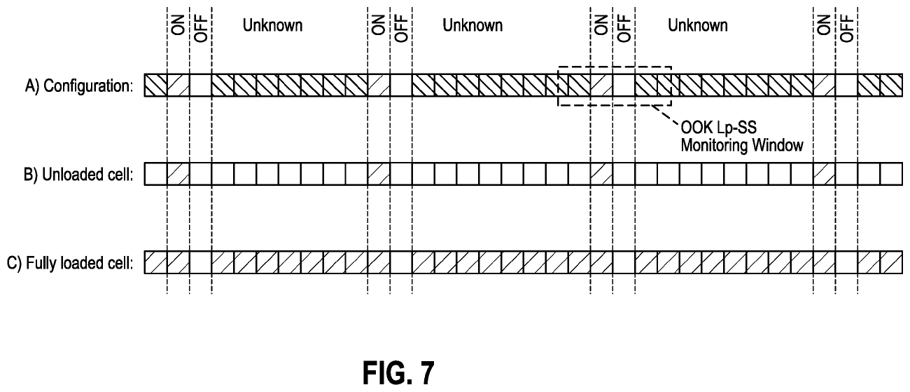

As seen in FIG. 7, at (A), the UE would from the configuration (e.g., provided to UE from gNB as part of the WUR configuration in system information broadcast) understand which symbols should be considered as ON and OFF symbols, but it would not know anything about what is transmitted in other symbols. In an unloaded cell (B), the UE cannot distinguish between OFF symbols and unused symbols. In a fully loaded cell (C), the UE cannot distinguish between ON symbols and used symbols (e.g., for dynamically scheduled transmission to other UEs). The UE would therefore need to apply pattern recognition and correlation with the configured ON-OFF pattern to determine when LP-SS is transmitted. If the UE starts completely unsynchronized, the UE will need to receive continuously using the WUR for some time to perform this pattern recognition/correlation and lock in on the LP-SS transmission. However, in practice, the UE will have performed an initial synchronization (and SI acquisition) using the MR (see above) and therefore have already have an understanding of when LP-SS (e.g., using legacy SSB) would be transmitted. This is however subject to UE clock drift, the WUR would most likely have a less accurate oscillator than the MR, and at the time of attempting to locate LP-SS for re-synchronization the UE's timing may have drifted somewhat. Therefore, the UE might have to apply a ‘LP-SS monitoring window’, as indicated in FIG. 7, to find the LP-SS and re-synchronize (the less accurate WUR oscillator, and the longer the LP-SS periodicity, the longer the LP-SS monitoring window would have to be). In one implementation the ‘LP-SS monitoring window’ is configured as part of the WUR configuration. For Idle/Inactive this could be configured for example in system information either common for all WUR UEs or providing different values for different WUR classes or types (UEs would apply the value matching their WUR UE capability reporting). For Connected the ‘LP-SS monitoring window’ could be configured UE-specifically as any value in a pre-determined range.

From the gNB perspective, the first periodic reference signal/transmissions are typically transmitted to support legacy UEs and also the UEs not receiving OOK based signaling. Then having a OOK based LP-SS with a separate set of ON symbols (e.g., separate from symbols used for SSB/TRS) would increase overhead and gNB energy consumption. With the approach described above, gNB can reuse the first periodic reference signal/transmissions as ON symbols for OOK based LP-SS for UEs operating in low power mode. This reduces overhead and gNB energy consumption.

From UE perspective, frequent availability of LP-SS ON symbols (e.g., with periodicity of SSB/TRS) enables better synchronization and more accurate measurements. This enables more energy efficient UE operation and improved WUR operation in low power mode.

In addition, some fallback mechanisms can be considered in which OOK-based WUR is disabled and not used for the LP-SS detection thus actions are done by the main receiver. The fallback conditions can be based on:
Availability, periodicity, and pattern of existing reference signals, SSB;
Length of the ON/OFF pattern for LP-SS;
Traffic patterns, cell load, presence of other transmissions, inter-cell interference, intra-cell interference;
Duty cycle operation, duty cycle parameters, latency requirements;
WUR architecture, UE capability, clock accuracy;
Coverage condition, UE battery level; or
UE mobility.

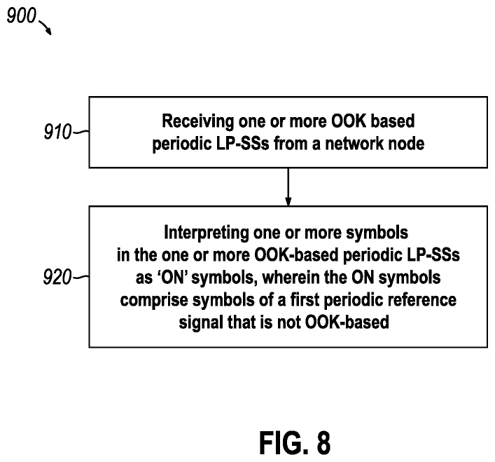

FIG. 8 shows a flow chart of a possible method embodiment under the present disclosure. Method 900 is a method performed by a UE. Step 910 is receiving one or more OOK based periodic LP-SSs from a network node. Step 920 is interpreting one or more symbols in the one or more OOK-based periodic LP-SSs as ‘ON’ symbols; wherein the ‘ON’ symbols comprise symbols of a first periodic reference signal that is not OOK-based. Method 900 can comprise a variety of additional, alternative, and/or optional steps or other variations.

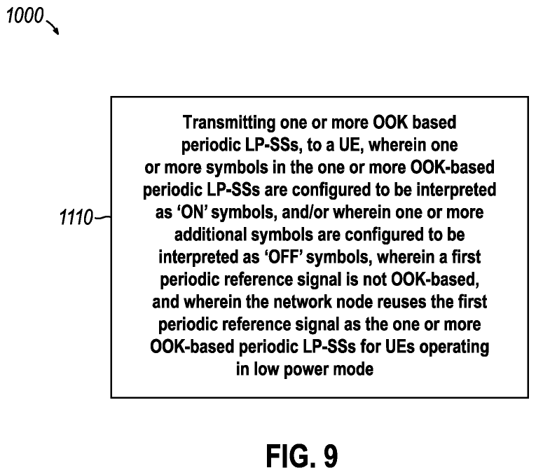

FIG. 9 shows another flow chart of a possible method embodiment under the present disclosure. Method 1100 is a method performed by a network node for transmitting a signal to a UE. Step 1110 is transmitting one or more OOK based periodic LP-SSs to a UE, wherein one or more symbols in the one or more OOK-based periodic LP-SSs are configured to be interpreted as ‘ON’ symbols, and/or wherein one or more additional symbols are configured to be interpreted as ‘OFF’ symbols, wherein a first periodic reference signal is not OOK-based, and wherein the network node reuses the first periodic reference signal as the one or more OOK based periodic LP-SSs for UEs operating in low power mode. Method 1100 can comprise a variety of additional, alternative, and/or optional steps or other variations.

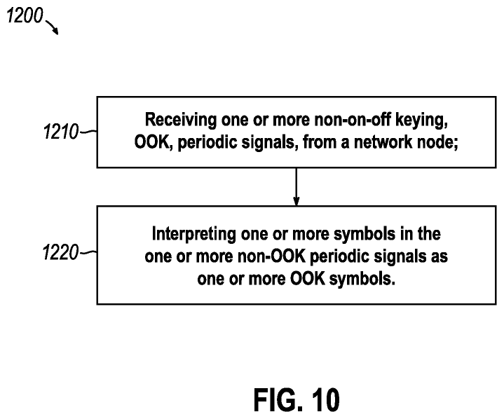

FIG. 10 shows another flow chart of a possible method embodiment 1200 under the present disclosure. Method 1200 is a method performed by a UE for interpreting symbols as OOK-based symbols. Step 1210 is receiving one or more non-OOK, periodic signals from a network node. Step 1220 is interpreting one or more symbols in the one or more non-OOK periodic signals as one or more OOK symbols. Method 1200 can comprise a variety of additional, alternative, and/or optional steps or other variations.

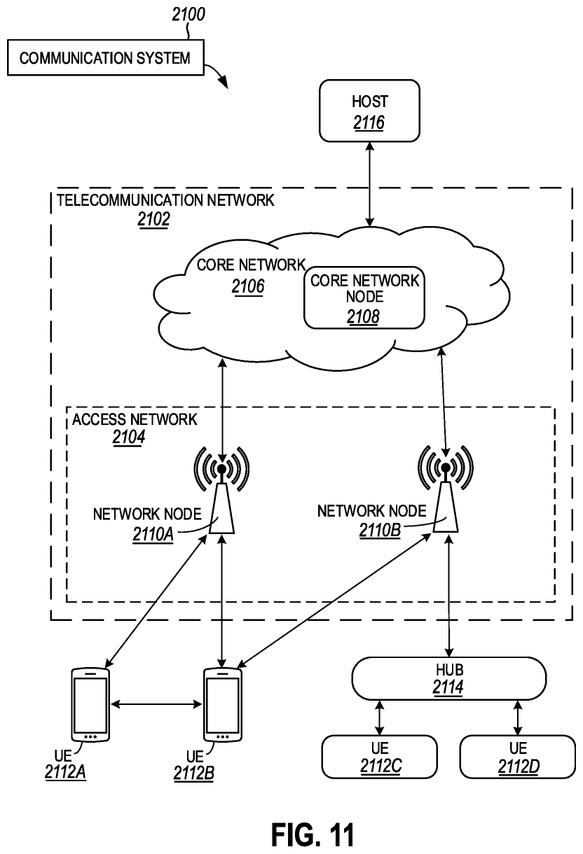

FIG. 11 shows an example of a communication system 2100 in accordance with some embodiments. In the example, the communication system 2100 includes a telecommunication network 2102 that includes an access network 2104, such as a RAN, and a core network 2106, which includes one or more core network nodes 2108. The access network 2104 includes one or more access network nodes, such as network nodes 2110a and 2110b (one or more of which may be generally referred to as network nodes 2110), or any other similar 3rd Generation Partnership Project (3GPP) access node or non-3GPP access point. The network nodes 2110 facilitate direct or indirect connection of UE, such as by connecting UEs 2112a, 2112b, 2112c, and 2112d (one or more of which may be generally referred to as UEs 2112) to the core network 2106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 2100 may include and/or interface with any type of communication, telecommunication, data, cellular, radio network, and/or other similar type of system.

The UEs 2112 may be any of a wide variety of communication devices, including wireless devices arranged, configured, and/or operable to communicate wirelessly with the network nodes 2110 and other communication devices. Similarly, the network nodes 2110 are arranged, capable, configured, and/or operable to communicate directly or indirectly with the UEs 2112 and/or with other network nodes or equipment in the telecommunication network 2102 to enable and/or provide network access, such as wireless network access, and/or to perform other functions, such as administration in the telecommunication network 2102.

In the depicted example, the core network 2106 connects the network nodes 2110 to one or more hosts, such as host 2116. These connections may be direct or indirect via one or more intermediary networks or devices. In other examples, network nodes may be directly coupled to hosts. The core network 2106 includes one more core network nodes (e.g., core network node 2108) that are structured with hardware and software components. Features of these components may be substantially similar to those described with respect to the UEs, network nodes, and/or hosts, such that the descriptions thereof are generally applicable to the corresponding components of the core network node 2108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 2116 may be under the ownership or control of a service provider other than an operator or provider of the access network 2104 and/or the telecommunication network 2102, and may be operated by the service provider or on behalf of the service provider. The host 2116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 2100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 2102 is a cellular network that implements 3GPP standardized features. Accordingly, the telecommunications network 2102 may support network slicing to provide different logical networks to different devices that are connected to the telecommunication network 2102. For example, the telecommunications network 2102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 2112 are configured to transmit and/or receive information without direct human interaction. For instance, a UE may be designed to transmit information to the access network 2104 on a predetermined schedule, when triggered by an internal or external event, or in response to requests from the access network 2104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 2114 communicates with the access network 2104 to facilitate indirect communication between one or more UEs (e.g., UE 2112c and/or 2112d) and network nodes (e.g., network node 2110b). In some examples, the hub 2114 may be a controller, router, content source and analytics, or any of the other communication devices described herein regarding UEs. For example, the hub 2114 may be a broadband router enabling access to the core network 2106 for the UEs. As another example, the hub 2114 may be a controller that sends commands or instructions to one or more actuators in the UEs. Commands or instructions may be received from the UEs, network nodes 2110, or by executable code, script, process, or other instructions in the hub 2114. As another example, the hub 2114 may be a data collector that acts as temporary storage for UE data and, in some embodiments, may perform analysis or other processing of the data. As another example, the hub 2114 may be a content source. For example, for a UE that is a VR headset, display, loudspeaker or other media delivery device, the hub 2114 may retrieve VR assets, video, audio, or other media or data related to sensory information via a network node, which the hub 2114 then provides to the UE either directly, after performing local processing, and/or after adding additional local content. In still another example, the hub 2114 acts as a proxy server or orchestrator for the UEs, in particular in if one or more of the UEs are low energy IoT devices.

The hub 2114 may have a constant/persistent or intermittent connection to the network node 2110b. The hub 2114 may also allow for a different communication scheme and/or schedule between the hub 2114 and UEs (e.g., UE 2112c and/or 2112d), and between the hub 2114 and the core network 2106. In other examples, the hub 2114 is connected to the core network 2106 and/or one or more UEs via a wired connection. Moreover, the hub 2114 may be configured to connect to an M2M service provider over the access network 1104 and/or to another UE over a direct connection. In some scenarios, UEs may establish a wireless connection with the network nodes 2110 while still connected via the hub 2114 via a wired or wireless connection. In some embodiments, the hub 2114 may be a dedicated hub—that is, a hub whose primary function is to route communications to/from the UEs from/to the network node 2110b. In other embodiments, the hub 2114 may be a non-dedicated hub—that is, a device which is capable of operating to route communications between the UEs and network node 2110b, but which is additionally capable of operating as a communication start and/or end point for certain data channels.

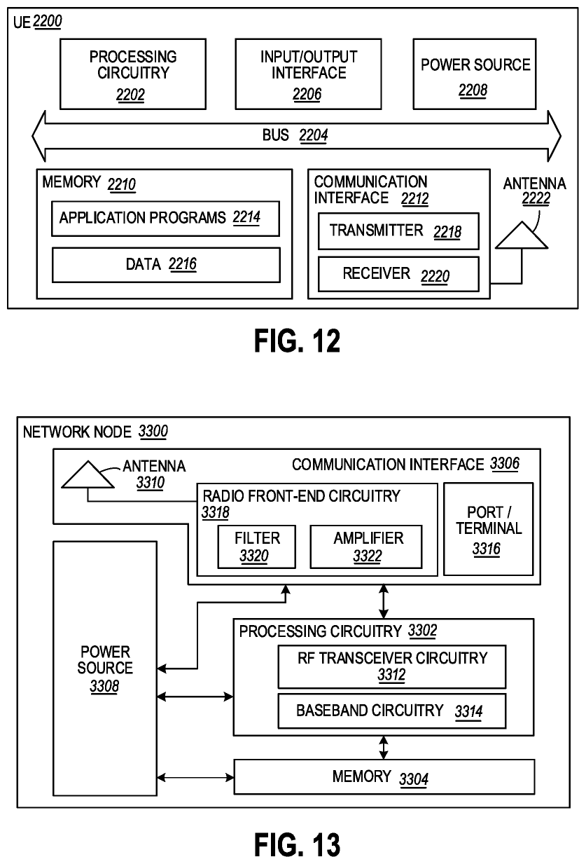

FIG. 12 shows a UE 2200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 2200 includes processing circuitry 2202 that is operatively coupled via a bus 2204 to an input/output interface 2206, a power source 2208, a memory 2210, a communication interface 2212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 2202 is configured to process instructions and data and may be configured to implement any sequential state machine operative to execute instructions stored as machine-readable computer programs in the memory 2210. The processing circuitry 2202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 2202 may include multiple central processing units (CPUs).

In the example, the input/output interface 2206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2208 is structured as a battery or battery pack. Other types of power sources, such as an external power source (e.g., an electricity outlet), photovoltaic device, or power cell, may be used. The power source 2208 may further include power circuitry for delivering power from the power source 2208 itself, and/or an external power source, to the various parts of the UE 2200 via input circuitry or an interface such as an electrical power cable. Delivering power may be, for example, for charging of the power source 2208. Power circuitry may perform any formatting, converting, or other modification to the power from the power source 2208 to make the power suitable for the respective components of the UE 2200 to which power is supplied.

The memory 2210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 2210 includes one or more application programs 2214, such as an operating system, web browser application, a widget, gadget engine, or other application, and corresponding data 2216. The memory 2210 may store, for use by the UE 2200, any of a variety of various operating systems or combinations of operating systems.

The memory 2210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 2210 may allow the UE 2200 to access instructions, application programs and the like, stored on transitory or non-transitory memory media, to off-load data, or to upload data. An article of manufacture, such as one utilizing a communication system may be tangibly embodied as or in the memory 2210, which may be or comprise a device-readable storage medium.

The processing circuitry 2202 may be configured to communicate with an access network or other network using the communication interface 2212. The communication interface 2212 may comprise one or more communication subsystems and may include or be communicatively coupled to an antenna 2222. The communication interface 2212 may include one or more transceivers used to communicate, such as by communicating with one or more remote transceivers of another device capable of wireless communication (e.g., another UE or a network node in an access network). Each transceiver may include a transmitter 2218 and/or a receiver 2220 appropriate to provide network communications (e.g., optical, electrical, frequency allocations, and so forth). Moreover, the transmitter 2218 and receiver 2220 may be coupled to one or more antennas (e.g., antenna 2222) and may share circuit components, software or firmware, or alternatively be implemented separately.

In the illustrated embodiment, communication functions of the communication interface 2212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 2212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 2200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 3300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 3300 includes a processing circuitry 3302, a memory 3304, a communication interface 3306, and a power source 3308. The network node 3300 may be composed of multiple physically separate components (e.g., a NodeB component and a RNC component, or a BTS component and a BSC component, etc.), which may each have their own respective components. In certain scenarios in which the network node 3300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 3304 for different RATs) and some components may be reused (e.g., a same antenna 3310 may be shared by different RATs). The network node 3300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 3302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 3300 components, such as the memory 3304, to provide network node 3300 functionality.

In some embodiments, the processing circuitry 3302 includes a system on a chip (SOC). In some embodiments, the processing circuitry 3302 includes one or more of radio frequency (RF) transceiver circuitry 3312 and baseband processing circuitry 3314. In some embodiments, the radio frequency (RF) transceiver circuitry 3312 and the baseband processing circuitry 3314 may be on separate chips (or sets of chips), boards, or units, such as radio units and digital units. In alternative embodiments, part or all of RF transceiver circuitry 3312 and baseband processing circuitry 3314 may be on the same chip or set of chips, boards, or units.

The memory 3304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 3302. The memory 3304 may store any suitable instructions, data, or information, including a computer program, software, an application including one or more of logic, rules, code, tables, and/or other instructions capable of being executed by the processing circuitry 3302 and utilized by the network node 3300. The memory 3304 may be used to store any calculations made by the processing circuitry 3302 and/or any data received via the communication interface 3306. In some embodiments, the processing circuitry 3302 and memory 3304 is integrated.

The communication interface 3306 is used in wired or wireless communication of signaling and/or data between a network node, access network, and/or UE. As illustrated, the communication interface 3306 comprises port(s)/terminal(s) 3316 to send and receive data, for example to and from a network over a wired connection. The communication interface 3306 also includes radio front-end circuitry 3318 that may be coupled to, or in certain embodiments a part of, the antenna 3310. Radio front-end circuitry 3318 comprises filters 3320 and amplifiers 3322. The radio front-end circuitry 3318 may be connected to an antenna 3310 and processing circuitry 3302. The radio front-end circuitry may be configured to condition signals communicated between antenna 3310 and processing circuitry 3302. The radio front-end circuitry 3318 may receive digital data that is to be sent out to other network nodes or UEs via a wireless connection. The radio front-end circuitry 3318 may convert the digital data into a radio signal having the appropriate channel and bandwidth parameters using a combination of filters 3320 and/or amplifiers 3322. The radio signal may then be transmitted via the antenna 3310. Similarly, when receiving data, the antenna 3310 may collect radio signals which are then converted into digital data by the radio front-end circuitry 3318. The digital data may be passed to the processing circuitry 3302. In other embodiments, the communication interface may comprise different components and/or different combinations of components.

In certain alternative embodiments, the network node 3300 does not include separate radio front-end circuitry 3318, instead, the processing circuitry 3302 includes radio front-end circuitry and is connected to the antenna 3310. Similarly, in some embodiments, all or some of the RF transceiver circuitry 3312 is part of the communication interface 3306. In still other embodiments, the communication interface 3306 includes one or more ports or terminals 3316, the radio front-end circuitry 3318, and the RF transceiver circuitry 3312, as part of a radio unit (not shown), and the communication interface 3306 communicates with the baseband processing circuitry 3314, which is part of a digital unit (not shown).

The antenna 3310 may include one or more antennas, or antenna arrays, configured to send and/or receive wireless signals. The antenna 3310 may be coupled to the radio front-end circuitry 3318 and may be any type of antenna capable of transmitting and receiving data and/or signals wirelessly. In certain embodiments, the antenna 3310 is separate from the network node 3300 and connectable to the network node 3300 through an interface or port.

The antenna 3310, communication interface 3306, and/or the processing circuitry 3302 may be configured to perform any receiving operations and/or certain obtaining operations described herein as being performed by the network node. Any information, data and/or signals may be received from a UE, another network node and/or any other network equipment. Similarly, the antenna 3310, the communication interface 3306, and/or the processing circuitry 3302 may be configured to perform any transmitting operations described herein as being performed by the network node. Any information, data and/or signals may be transmitted to a UE, another network node and/or any other network equipment.

The power source 3308 provides power to the various components of network node 3300 in a form suitable for the respective components (e.g., at a voltage and current level needed for each respective component). The power source 3308 may further comprise, or be coupled to, power management circuitry to supply the components of the network node 3300 with power for performing the functionality described herein. For example, the network node 3300 may be connectable to an external power source (e.g., the power grid, an electricity outlet) via an input circuitry or interface such as an electrical cable, whereby the external power source supplies power to power circuitry of the power source 3308. As a further example, the power source 3308 may comprise a source of power in the form of a battery or battery pack which is connected to, or integrated in, power circuitry. The battery may provide backup power should the external power source fail.

Embodiments of the network node 3300 may include additional components beyond those shown in FIG. 13 for providing certain aspects of the network node's functionality, including any of the functionality described herein and/or any functionality necessary to support the subject matter described herein. For example, the network node 3300 may include user interface equipment to allow input of information into the network node 3300 and to allow output of information from the network node 3300. This may allow a user to perform diagnostic, maintenance, repair, and other administrative functions for the network node 3300.

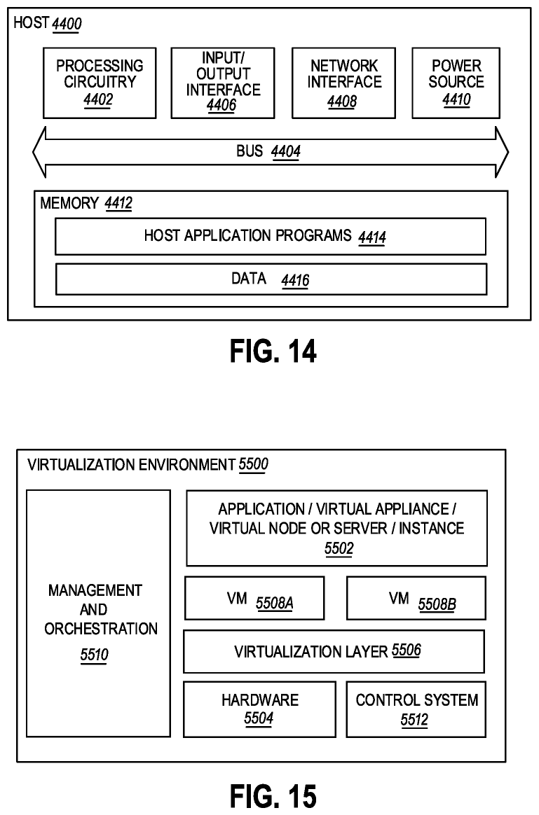

FIG. 14 is a block diagram of a host 4400, which may be an embodiment of the host 2116 of FIG. 11, in accordance with various aspects described herein. As used herein, the host 4400 may be or comprise various combinations hardware and/or software, including a standalone server, a blade server, a cloud-implemented server, a distributed server, a virtual machine, container, or processing resources in a server farm. The host 4400 may provide one or more services to one or more UEs.

The host 4400 includes processing circuitry 4402 that is operatively coupled via a bus 4404 to an input/output interface 4406, a network interface 4408, a power source 4410, and a memory 4412. Other components may be included in other embodiments. Features of these components may be substantially similar to those described with respect to the devices of previous figures, such as FIGS. 10 and 11, such that the descriptions thereof are generally applicable to the corresponding components of host 4400.

The memory 4412 may include one or more computer programs including one or more host application programs 4414 and data 4416, which may include user data, e.g., data generated by a UE for the host 4400 or data generated by the host 4400 for a UE. Embodiments of the host 4400 may utilize only a subset or all of the components shown. The host application programs 4414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 4414 may also provide for user authentication and licensing checks and may periodically report health, routes, and content availability to a central node, such as a device in or on the edge of a core network. Accordingly, the host 4400 may select and/or indicate a different host for over-the-top services for a UE. The host application programs 4414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 5500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 5500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 5502 (which may alternatively be called software instances, virtual appliances, network functions, virtual nodes, virtual network functions, etc.) are run in the virtualization environment 5500 to implement some of the features, functions, and/or benefits of some of the embodiments disclosed herein.

Hardware 5504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 5506 (also referred to as hypervisors or virtual machine monitors (VMMs)), provide VMs 5508a and 5508b (one or more of which may be generally referred to as VMs 5508), and/or perform any of the functions, features and/or benefits described in relation with some embodiments described herein. The virtualization layer 5506 may present a virtual operating platform that appears like networking hardware to the VMs 5508.

The VMs 5508 comprise virtual processing, virtual memory, virtual networking or interface and virtual storage, and may be run by a corresponding virtualization layer 5506. Different embodiments of the instance of a virtual appliance 5502 may be implemented on one or more of VMs 5508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 5508 may be a software implementation of a physical machine that runs programs as if they were executing on a physical, non-virtualized machine. Each of the VMs 5508, and that part of hardware 5504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 5508 on top of the hardware 5504 and corresponds to the application 5502.

Hardware 5504 may be implemented in a standalone network node with generic or specific components. Hardware 5504 may implement some functions via virtualization. Alternatively, hardware 5504 may be part of a larger cluster of hardware (e.g., such as in a data center or CPE) where many hardware nodes work together and are managed via management and orchestration 5510, which, among others, oversees lifecycle management of applications 5502. In some embodiments, hardware 5504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 5512 which may alternatively be used for communication between hardware nodes and radio units.

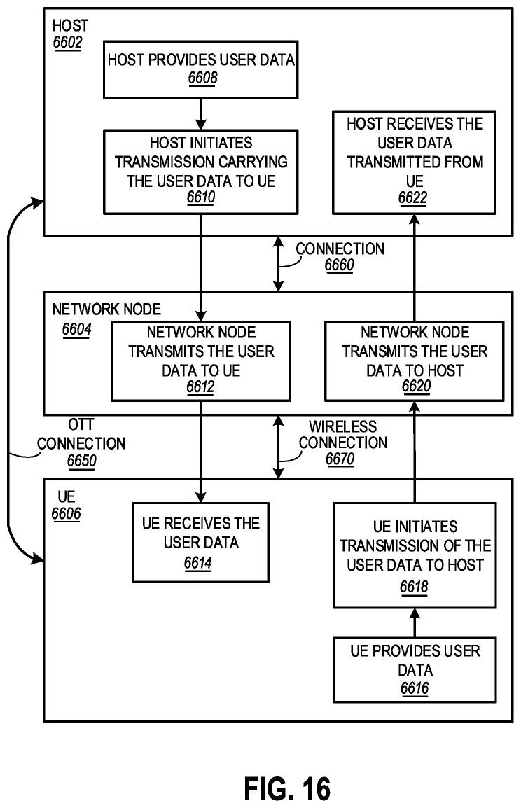

FIG. 16 shows a communication diagram of a host 6602 communicating via a network node 6604 with a UE 6606 over a partially wireless connection in accordance with some embodiments. Example implementations, in accordance with various embodiments, of the UE (such as a UE 2112a of FIG. 11 and/or UE 2200 of FIG. 12), network node (such as network node 2110a of FIG. 11 and/or network node 3300 of FIG. 13), and host (such as host 2116 of FIG. 11 and/or host 4400 of FIG. 14) discussed in the preceding paragraphs will now be described with reference to FIG. 16.

Like host 4400, embodiments of host 6602 include hardware, such as a communication interface, processing circuitry, and memory. The host 6602 also includes software, which is stored in or accessible by the host 6602 and executable by the processing circuitry. The software includes a host application that may be operable to provide a service to a remote user, such as the UE 6606 connecting via an over-the-top (OTT) connection 6650 extending between the UE 6606 and host 6602. In providing the service to the remote user, a host application may provide user data which is transmitted using the OTT connection 6650.

The network node 6604 includes hardware enabling it to communicate with the host 6602 and UE 6606. The connection 6660 may be direct or pass through a core network (like core network 2106 of FIG. 11) and/or one or more other intermediate networks, such as one or more public, private, or hosted networks. For example, an intermediate network may be a backbone network or the Internet.

The UE 6606 includes hardware and software, which is stored in or accessible by UE 6606 and executable by the UE's processing circuitry. The software includes a client application, such as a web browser or operator-specific “app” that may be operable to provide a service to a human or non-human user via UE 6606 with the support of the host 6602. In the host 6602, an executing host application may communicate with the executing client application via the OTT connection 6650 terminating at the UE 6606 and host 6602. In providing the service to the user, the UE's client application may receive request data from the host's host application and provide user data in response to the request data. The OTT connection 6650 may transfer both the request data and the user data. The UE's client application may interact with the user to generate the user data that it provides to the host application through the OTT connection 6650.

The OTT connection 6650 may extend via a connection 6660 between the host 6602 and the network node 6604 and via a wireless connection 6670 between the network node 6604 and the UE 6606 to provide the connection between the host 6602 and the UE 6606. The connection 6660 and wireless connection 6670, over which the OTT connection 6650 may be provided, have been drawn abstractly to illustrate the communication between the host 6602 and the UE 1606 via the network node 6604, without explicit reference to any intermediary devices and the precise routing of messages via these devices.

As an example of transmitting data via the OTT connection 6650, in step 6608, the host 6602 provides user data, which may be performed by executing a host application. In some embodiments, the user data is associated with a particular human user interacting with the UE 6606. In other embodiments, the user data is associated with a UE 6606 that shares data with the host 6602 without explicit human interaction. In step 6610, the host 6602 initiates a transmission carrying the user data towards the UE 6606. The host 6602 may initiate the transmission responsive to a request transmitted by the UE 6606. The request may be caused by human interaction with the UE 6606 or by operation of the client application executing on the UE 6606. The transmission may pass via the network node 6604, in accordance with the teachings of the embodiments described throughout this disclosure. Accordingly, in step 6612, the network node 6604 transmits to the UE 6606 the user data that was carried in the transmission that the host 6602 initiated, in accordance with the teachings of the embodiments described throughout this disclosure. In step 6614, the UE 6606 receives the user data carried in the transmission, which may be performed by a client application executed on the UE 6606 associated with the host application executed by the host 6602.

In some examples, the UE 6606 executes a client application which provides user data to the host 6602. The user data may be provided in reaction or response to the data received from the host 6602. Accordingly, in step 6616, the UE 6606 may provide user data, which may be performed by executing the client application. In providing the user data, the client application may further consider user input received from the user via an input/output interface of the UE 6606. Regardless of the specific manner in which the user data was provided, the UE 6606 initiates, in step 6618, transmission of the user data towards the host 6602 via the network node 6604. In step 6620, in accordance with the teachings of the embodiments described throughout this disclosure, the network node 6604 receives user data from the UE 6606 and initiates transmission of the received user data towards the host 6602. In step 6622, the host 6602 receives the user data carried in the transmission initiated by the UE 6606.

One or more of the various embodiments improve the performance of OTT services provided to the UE 6606 using the OTT connection 6650, in which the wireless connection 6670 forms the last segment. More precisely, the teachings of these embodiments may improve the data rate, latency, and/or power consumption and thereby provide benefits such as reduced user waiting time, relaxed restriction on file size, improved content resolution, better responsiveness, and/or extended battery lifetime.

In an example scenario, factory status information may be collected and analyzed by the host 6602. As another example, the host 6602 may process audio and video data which may have been retrieved from a UE for use in creating maps. As another example, the host 6602 may collect and analyze real-time data to assist in controlling vehicle congestion (e.g., controlling traffic lights). As another example, the host 6602 may store surveillance video uploaded by a UE. As another example, the host 6602 may store or control access to media content such as video, audio, VR or AR which it can broadcast, multicast or unicast to UEs. As other examples, the host 6602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 6650 between the host 6602 and UE 6606, in response to variations in the measurement results. The measurement procedure and/or the network functionality for reconfiguring the OTT connection may be implemented in software and hardware of the host 6602 and/or UE 6606. In some embodiments, sensors (not shown) may be deployed in or in association with other devices through which the OTT connection 6650 passes; the sensors may participate in the measurement procedure by supplying values of the monitored quantities exemplified above, or supplying values of other physical quantities from which software may compute or estimate the monitored quantities. The reconfiguring of the OTT connection 6650 may include message format, retransmission settings, preferred routing etc.; the reconfiguring need not directly alter the operation of the network node 6604. Such procedures and functionalities may be known and practiced in the art. In certain embodiments, measurements may involve proprietary UE signaling that facilitates measurements of throughput, propagation times, latency and the like, by the host 6602. The measurements may be implemented in that software causes messages to be transmitted, in particular empty or ‘dummy’ messages, using the OTT connection 6650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1. A method performed by a user equipment, UE, the method comprising:
receiving one or more on-off keying, OOK, based periodic lower power synchronization signals, LP-SSs, from a network node;
interpreting one or more symbols in the one or more OOK-based periodic LP-SSs as ‘ON’ symbols, wherein the ‘ON’ symbols comprise symbols of a first periodic reference signal that is not OOK-based.

2. The method of claim 1 further comprising interpreting one or more additional symbols of OOK-based LP-SS as ‘OFF’ symbols.

3. The method of claim 1, wherein the first periodic reference signal comprises at least one of: one or more Synchronization Signal Block, SSB, symbols; one or more Tracking Reference Signals, TRS, symbols.

4. The method of claim 1, further comprising;
receiving one or more additional OOK periodic signals, and
interpreting one or more additional symbols in the one or more additional OOK periodic signals as ‘OFF’ symbols.

5. The method of claim 1, wherein the one or more OOK-based periodic LP-SSs are used for at least one of: Radio Resource Management, RRM, measurements; obtaining time-frequency synchronization data; obtaining automatic gain control, AGC, data.

6. The method of claim 1, wherein the ‘ON’ symbols comprise symbols of a first periodic reference signal and wherein the first non-OOK periodic reference signal is at least one of: one or more Synchronization Signal Block, SSB, symbols; one or more Tracking Reference Signals, TRS, symbols.

7. The method of claim 1, wherein the one or more additional symbols are adjacent to one or more Synchronization Signal Block, SSB, symbols or one or more Tracking Reference Signals, TRS, symbols.

8. The method of claim 1, wherein the UE interprets ‘OFF’ symbols based on base station signalling.

9. The method of claim 1, wherein the ‘OFF’ symbols are configured around a subset of Synchronization Signal Block, SSB, bursts or Tracking Reference Signals, TRS, bursts.

10. The method of claim 1, wherein the UE interprets ‘ON’ symbols based on base station signalling.

11. The method of claim 1, wherein only a subset of one or more Synchronization Signal Block, SSB, symbols or one or more Tracking Reference Signals, TRS, symbols are utilized as ‘ON’ symbols.

12. The method of claim 1, wherein the one or more OOK-based periodic LP-SSs comprise OFDM symbols.

13. (canceled)

14. The method of claim 1, wherein if the UE has a main receiver and low power WUR, the LP-SS can be used by UE's WUR while the first periodic reference signal can then be used by UE's MR.

15. The method of claim 1, wherein upon detection of a wake up signal, WUS, the UE's MR may use the first periodic reference signal to obtain time or frequency synchronization or Automatic Gain Control, AGC, tuning to prepare the UE to receive other New Radio, NR, transmissions.

16. The method of claim 1, wherein interactions and information exchanges between a wake up receiver, WUR, and main receiver, MR, are done periodically or in an event-triggered manner.

17. The method of claim 1, wherein one or more specific LP-SS on/off patterns is explicitly indicated via bitmaps.

18-22. (canceled)

23. A method performed by a network node for transmitting a signal to a user equipment, UE, the method comprising:
transmitting one or more on-off keying, OOK, based periodic lower power synchronization signals, LP-SSs, to a UE, wherein one or more symbols in the one or more OOK-based periodic LP-SSs are configured to be interpreted as ‘ON’ symbols, and/or wherein one or more additional symbols are configured to be interpreted as ‘OFF’ symbols, wherein a first periodic reference signal are not OOK-based, and wherein the network node reuses the first periodic reference signal as the one or more OOK based periodic LP-SSs for UEs operating in low power mode.

24. The method of claim 23, wherein the transmitting is performed to support one or more legacy UEs and one or more UEs not receiving OOK based signaling.

25. A user equipment, UE, comprising:
processing circuitry configured to perform the steps of claim 1; and
power supply circuitry configured to supply power to the processing circuitry.

26. (canceled)

27. A network node for transmitting a signal to a user equipment, UE, the network node comprising:
processing circuitry configured to perform the steps of claim 23; and
power supply circuitry configured to supply power to the processing circuitry.
